(19) United States
(12) Patent Application Publication
(10) Pub. No.: US 2020/0098030 A1
(43) Pub. Date: Mar. 26, 2020

(54) INVENTORY-ASSISTED ARTIFICIAL INTELLIGENCE RECOMMENDATION ENGINE

(71) Applicant: salesforce.com, Inc., San Francisco, CA (US)

(72) Inventors: George Pizza, San Francisco, CA (US); Amanda Hatker, San Francisco, CA (US)

(21) Appl. No.: 16/140,015

(22) Filed: Sep. 24, 2018

(51) Int. Cl. G06Q 30/06; G06Q 30/02; H04L 29/08; G06N 20/00

(52) U.S. Cl. CPC G06Q 30/0631; G06N 20/00; H04L 67/306; G06Q 30/0204

(57) ABSTRACT

A method of generating digital data content customized for a user of a digital data platform includes determining, through artificial intelligence, potential interests of a user of a digital data platform and generating, through that same intelligence, a product recommendation based on the determined interests. The method further includes aggregating data from plural disparate sources regarding inventory availability and filtering the aggregated data in accord with the product recommendation. The product recommendation is transferred to a client digital data device for presentation to the user along with the inventory availability.

### BACKGROUND

This pertains to automatically generated digital data content and, more particularly, digital content generated through application of artificial intelligence. It has use, by way of non-limiting example, in the automatic generation of digital content for recommendations presented to users of e-commerce and other sites.

Any e-commerce retailer will tell you that search is no longer enough. Customers will use it when they have a particular product in mind. Those visiting an e-commerce site for a casual browse may not. They need ideas. Even the purpose-minded customer does. Hence, the recommendation engine. It can recommend products and other items of interest to site visitors based on browsing and shopping trends of the user and others.

Recommendations can lead to disappointment, unfortunately. A shopper may be thrilled to learn from a pop-up that a particular item is trending among other web customers. But if clicking the recommendation reveals that item is no longer in stock, good will is lost—and the shopper may well turn to a competitor to whet his or her appetite. The art has suggested various solutions, but they have not proven satisfactory.

### BRIEF DESCRIPTION OF THE DRAWINGS

A more complete understanding of the discussion that follows may be attained by reference to the drawings, in which:

FIG. 1 depicts an environment in which an embodiment is employed;

FIG. 2 depicts an embodiment for inventory-assisted artificial intelligence recommendation generation.

### DETAILED DESCRIPTION OF THE ILLUSTRATED EMBODIMENT

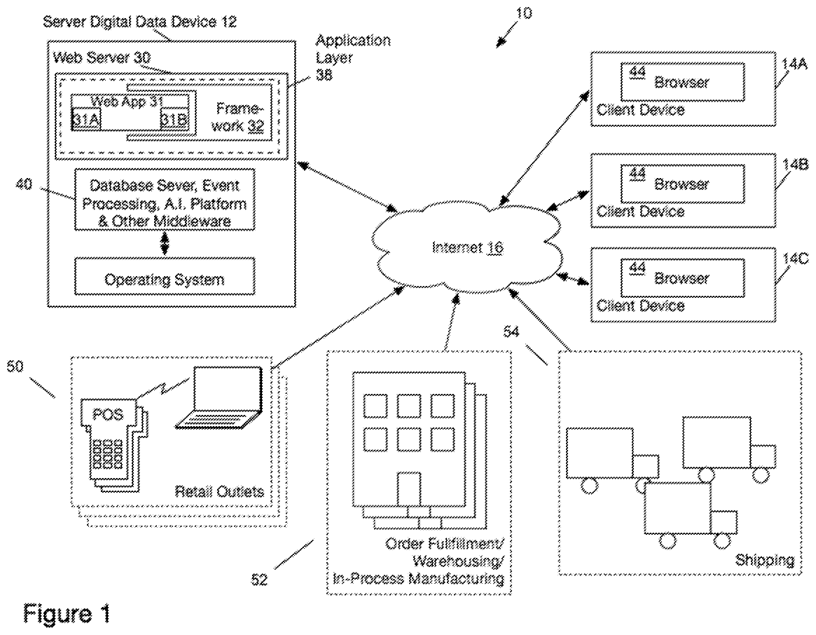

FIG. 1 depicts a digital data processing system 10 that includes a server digital data device (“server”) 12 coupled to client digital data devices (“clients”) 14A-14C via a network 16. By way of non-limiting example, illustrated server 12 hosts an e-commerce portal or platform (collectively, “platform”) of an online retailer, and clients 14A-14C are digital devices (e.g., smart phones, desktop computers, and so forth) of customers of that retailer and other users (collectively, “users”) of that platform.

Devices 12, 14A-14C comprise conventional desktop computers, workstations, minicomputers, laptop computers, tablet computers, PDAs, mobile phones or other digital data devices of the type that are commercially available in the marketplace, all as adapted in accord with the teachings hereof. Thus, each comprises central processing, memory, and input/output subsections (not shown here) of the type known in the art and suitable for (i) executing software of the type described herein and/or known in the art (e.g., applications software, operating systems, and/or middleware, as applicable) as adapted in accord with the teachings hereof and (ii) communicating over network 16 to other devices 12, 14A-14C in the conventional manner known in the art as adapted in accord with the teachings hereof.

Examples of such software include web server 30 that executes on device 12 and that responds to requests in HTTP or other protocols from clients 14A-14C (and, more particularly, from the users thereof) for transferring web pages, downloads and other digital content to the requesting device over network 16, in the conventional manner known in the art as adapted in accord with the teachings hereof. Web server 30 includes web application 31 that includes a data-aggregating and distributing function 31A and a recommender 31B, both of which may be part of broader functionality provided by the web application 31 such as, for example, serving up a web site or web service (collectively, “web site”) to client devices, all per convention in the art as adapted in accord with the teachings hereof. That web site is, by way of non-limiting example, an e-commerce site of a retailer, e.g., for advertising and selling goods to its customers, per convention in the art as adapted in accord with the teachings hereof.

Data-aggregating and distributing function 31A of the illustrated embodiment is, by way of non-limiting example, an inventory function that aggregates data regarding inventory available to those customers from the disparate sources from which the retailer obtains goods for customer order and/or purchase, per convention in the art as adapted in accord with the teachings hereof. In the illustrated embodiment, those sources comprise brick-and-mortar outlets 50, order fulfillment, warehousing, and/or in-process manufacturing locations 52, and in-transit shipping 54, though, other embodiments may vary in this regard.

Recommender 31B is a server-side front-end of an artificial intelligence-based platform 66 that includes a recommendation engine of the type that (i) generates digital data content, particularly, recommendations, customized for presentation to users that visit the site, e.g., via their respective client devices 14A-14C and browsers 44, and (ii) through those front-ends, transmits that content (i.e., those recommendations) to those client devices 14A-14C for presentation to the users thereof via their respective browsers, e.g., as part of web pages, downloads and other digital content per convention in the art as adapted in accord with the teachings hereof. In addition to facilitating transmitting the aforesaid content to the browsers 44 of client devices 14A-14C, the recommender 31B facilitates monitoring behavior of the users of those browsers and otherwise obtaining user data (from the browsers, from user-account databases accessible by server 12, and otherwise) for processing by the platform 66. In an embodiment, such as that illustrated here, where server 12 hosts an e-commerce web site, the recommendations can be for goods or services (collectively, “goods” or “products”) that may of interest to the user in inventory at retail outlets near, favorited by and/or frequented by the user (collectively, “product recommendations”), though, other embodiments may vary in this regard.

Recommendation engine is an artificial intelligence recommender system of the type commercially available in the marketplace that utilizes one or more of machine learning, deep learning, predictive analytics, natural language processing and smart data discovery to generate the recommendations based on models learned and tuned from data regarding each user and his/her browsing, purchase and other behaviors (e.g., as discerned from the user's current activity on a browser, cookies on his/her client device 14A-14C, and store and other user accounts maintained on the with the site, and otherwise), as well as from other indicators of his/her interests (e.g., as reflected by postings on social networks and so forth), and from similar information from other users of like demographic or otherwise, all per convention in the art as adapted in accord with the teachings hereof.

Web framework 32 comprises conventional such software known in the art (as adapted in accord with the teachings hereof) providing libraries and other reusable services that are (or can be) employed—e.g., via an applications program interface (API) or otherwise—by multiple and/or a variety of web applications executing on the platform supported by server 12, one of which applications is shown here (to wit, web application 31).

In the illustrated embodiment, web server 30 and its constituent components, web application 31 and framework 32, execute within an application layer 38 of the server architecture. That layer 38, which provides services and supports communications protocols in the conventional manner known in the art as adapted in accord with the teachings hereof, can be distinct from other layers in the server architecture—layers that provide services and, more generally, resources (a/k/a “server resources”) that are required by the web application 31 and/or framework 32 in order to process at least some of the requests received by server 30 from clients 14A-14C and to obtain inventory (and/or other) data for aggregation, e.g., from outlets 50, locations 52, and so forth, all per convention in the art as adapted in accord with the teachings hereof.

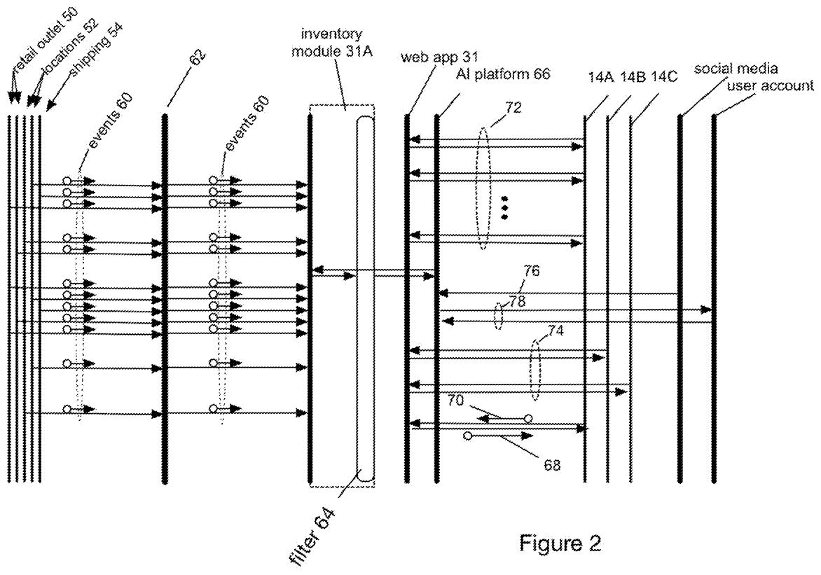

Those other layers include, for example, a data layer 40—which provides middleware including an event processing framework 62 (FIG. 2), artificial intelligence platform 66 (FIG. 2), and which supports interaction with a database server 40, all in the conventional manner known in the art as adapted in accord with the teachings hereof and all by way of non-limiting example—and the server's operating system 42, which manages the server hardware and software resources and provides common services for software executing thereon in the conventional manner known in the art as adapted in accord with the teachings hereof. Other embodiments may utilize an architecture with a greater or lesser number of layers and/or with layers providing different respective functionalities than those illustrated here.

Though described here in the context of a web site, in other embodiments web server 30, application 31 and framework 32 may define a web service or other functionality (e.g., available through an API or otherwise) suitable for responding to user requests, e.g., a video server, a music server, or otherwise. And, though shown and discussed here as comprising a separate web application 31 and framework 32, in other embodiments, the web server 30 may combine the functionality of illustrated components 31 and 32 in a single component or distribute it among still more components.

With continued reference to FIG. 1, client devices 14A-14C of the illustrated embodiment execute web browsers 44 that (typically) operate under user control to generate requests in HTTP or other protocols, e.g., to access web sites on the aforementioned platform, to search for goods available on, through or in connection with that platform (e.g., goods available from a web site retailer—whether online and/or through its brick-and-mortar outlets), to advance-order or request the purchase (or other acquisition) of those goods, and so forth, and to transmit those requests to web server 30 over network 14—all in the conventional manner known in the art as adapted in accord with the teachings hereof.

Though referred to here as web browsers, in other embodiments applications 44 may comprise web apps or other other functionality suitable for transmitting requests to a server 30 and/or presenting content received therefrom in response to those requests, e.g., a video player application, a music player application or otherwise.

The devices 12, 14A-14C of the illustrated embodiment may be of the same type, though, more typically, they constitute a mix of devices of differing types. And, although only a single server digital data device 12 is depicted and described here, it will be appreciated that other embodiments may utilize a greater number of these devices, homogeneous, heterogeneous or otherwise, networked or otherwise, to perform the functions ascribed hereto to web server 30 and/or digital data processor 12. Likewise, although three client devices 14A-14C are shown, it will be appreciated that other embodiments may utilize a greater or lesser number of those devices, homogeneous, heterogeneous or otherwise, running applications (e.g., 44) that are, themselves, as noted above, homogeneous, heterogeneous or otherwise. Moreover, one or more of devices 12, 14A-14C may be configured as and/or to provide a database system (including, for example, a multi-tenant database system) or other system or environment; and, although shown here in a client-server architecture, the devices 12, 14A-14C may be arranged to interrelate in a peer-to-peer, client-server or other protocol consistent with the teachings hereof.

Retail outlets 50 comprise one or more brick-and-mortar or other facilities from which customers can obtain goods per convention in the art as adapted in accord with the teachings hereof. Illustrated outlets 50 include (or are otherwise associated with) digital data processing equipment coupled to network 16 for transferring information, e.g., to server 12 or otherwise, regarding inventory availability per convention in the art as adapted in accord with the teachings hereof. The outlets can include point-of-sale (POS) terminals, back-office or other digital data processing equipment (not shown) capable of at least generating and transmitting on network 16 information to that server 12 or otherwise regarding (i) on-hand inventory, (ii) inventory subject to in-process orders (e.g., inventory on reserve for customers while awaiting order completion and/or payment), and/or (iii) inventory in reserve for demonstration or display to prospective customers and, thus, not available for purchase. Such information can be collected and generated at the respective outlets in the conventional manner known in the art as adapted in accord with the teachings hereof (e.g., via POS logging, attendant-equipped bar scanners, etc.) on a per-SKU (stock-keeping unit), per-UPC (universal product code), or other basis, again, per convention in art as adapted in accord with the teachings hereof. The transmission of such data on network 16 is within the ken of those skilled in the art as informed by the teachings hereof.

Locations 52 comprise one or more order fulfillment, warehousing, in-process manufacturing or other locations from which a retailer can obtain a supply of goods to reasonably meet customer orders. As above, illustrated locations 52 include (or are otherwise associated with) digital data processing equipment coupled with network 16 for generating and/or transferring information, e.g., to server 12 or otherwise, regarding inventory availability per convention in the art as adapted in accord with the teachings hereof. This can include inventory that is ready for shipment directly to customers and/or to retail outlets 50, as well as inventory for which manufacturing is (or can be) in-process and, thus, can also be ready for shipment in reasonable time, all per convention in the art as adapted in accord with the teachings hereof. As above, such information can be collected and generated at the respective locations 52 in the conventional manner known in the art as adapted in accord with the teachings hereof, e.g., on a per-SKU, per-UPC, or other basis, and it can be transmitted on network 16 in a conventional manner known in the art, again, too, as adapted in accord with the teachings hereof.

In transit shipping 54 comprise one or more transports via which goods are routed to and between outlets 50 and locations 52 per convention in the art as adapted in accord with the teachings hereof. These include (or are otherwise associated with) digital data processing and/or other equipment, including for example RFID-equipped or otherwise sensorized pallets, containers and the like, suitable for generating and/or transferring information, e.g., to server 12 or otherwise, regarding inventory availability per convention in the art as adapted in accord with the teachings hereof. This can include inventory that is currently en route and/or is being readied therefor, as well as inventory that has been delivered and is being readied for stocking at an outlet 50 or location 52, all per convention in the art as adapted in accord with the teachings hereof. As above, such information can be collected and generated in connection with shipping in the conventional manner known in the art as adapted in accord with the teachings hereof, e.g., on a per-SKU, per-UPC, or other basis, and it can be transmitted on network 16 in a conventional manner known in the art, again, too, as adapted in accord with the teachings hereof.

Network 16 is a distributed network comprising one or more networks suitable for supporting communications between server 12 and client device 14A-14C. The network comprises one or more arrangements of the type known in the art, e.g., local area networks (LANs), wide area networks (WANs), metropolitan area networks (MANs), and or Internet(s). Although a client-server architecture is shown in the drawing, the teachings hereof are applicable to digital data devices coupled for communications in other network architectures.

As those skilled in the art will appreciate, the “software” referred to herein—including, by way of non-limiting example, web server 30 and its constituent components, web application 31 and web application framework 32, browser 44—comprise computer programs (i.e., sets of computer instructions) stored on transitory and non-transitory machine-readable media of the type known in the art as adapted in accord with the teachings hereof, which computer programs cause the respective digital data devices, e.g., 12, 14A-14C to perform the respective operations and functions attributed thereto herein. Such machine-readable media can include, by way of non-limiting example, hard drives, solid state drives, and so forth, coupled to the respective digital data devices 12, 14A-14C in the conventional manner known in the art as adapted in accord with the teachings hereof.

Described below in connection with FIG. 2 is operation of the web application 31 in connection with AI platform 66, as well as with other components of the illustrated system 10, to generate and transfer an inventory-assisted AI recommendation 68 to a user of client device, e.g., 14A, via the browser 44 executing thereon. This can be in response to a request 70 for such a recommendation generated by its respective web browser 44 and, more particularly, by way of non-limiting example, in response to a request for such a recommendation generated by a “recommender” widget or other code executing in a web page or other content downloaded by and presented on that browser 44, or otherwise, as per convention in the art as adapted in accord with the teachings hereof.

In order to respond to that request and to generate a recommendation 68, the web application 31 invokes (i) recommender 31B to obtain a product recommendation from platform 66 (for which recommender 31B serves as a front-end) based on the user's browsing, purchase and/or other behaviors, as well as from other indicators of his/her interests, and/or from similar information from other users of like demographic or otherwise, and (ii) inventory module 31A to obtain inventory data aggregated for that product from and outlets 50, locations 52 and shipping transports 54 and/or other sources from which the retailer obtains goods for customer order and/or purchase and filtered to match the particular recommendation.

As noted above, platform 66 generates a product recommendation based on the behavior of the user to whom the recommendation is being delivered (e.g., the user of device 14A), as well as on other indicators of his/her interest, and on similar information of other users. To that end, the platform 66 monitors, continually or otherwise, web pages, files and other content downloaded to browser 44 of the client device 14A as well as the user's responses to those downloads and/or other interactions with the web site (and, more generally, server 12). From those interactions, denoted in the drawing as communications 72, the platform utilizes artificial intelligence to discern the user's interests, all in the conventional manner known in the art as adapted in accord with the teachings hereof. The platform 66 can likewise monitor communications between the web site and users of other client devices 14B-14C, again, per convention in the art as adapted in accord with the teachings hereof. From those interactions, the platform 66 can infer trends and/or interests (e.g., of the user of device 14A) in the conventional manner known in the art as adapted in accord with the teachings hereof. The platform can make further such inferences by monitoring social media feeds 76, whether targeted to the population as a whole and/or to a specific individual (here, for example, the user of device 14A), again, all per convention in the art as adapted in accord with the teachings hereof. Further evidence of user behavior and/or interests is provided by account databases and other information maintained by or accessible to platform 66, which requests and obtains that information as shown by communications 78, all per convention in the art as adapted in accord with the teachings hereof. Those skilled in the art will appreciate that platform 66 can perform the aforesaid monitoring through utilization of it's role in the middleware of server 12, through the front-end 31B and/or otherwise as per convention in the art as adapted in accord with the teachings hereof.

Once a product recommendation is obtained from platform 66 (e.g., via recommender 31B), the web application 31 utilizes that to obtain inventory information aggregated from outlets 50, locations 52 and shipping transports 54 and other sources. As evident in the discussion below, that invocation can be in response to a request 70 issued by a “recommender” widget or other code in a web page or other content downloaded by and presented on that browser 44, or otherwise, as per convention in the art as adapted in accord with the teachings hereof, though other embodiments may vary in this regard.

Referring back to FIG. 2, respective digital data processing equipment of outlets 50, locations 52 and shipping transports 54 of the illustrated embodiment transfer respective inventory data to server 12 via a publish-and-subscribe event processing protocol of the type commercially available in the marketplace as adapted in accord with the teachings hereof. Thus, each such outlet 50, location 52 and/or shipping transport 54 generates and transmits an “event” 60 to network 16 with each inventory change. Those events can reflect then-current totals of inventory at the respective outlets 50, locations 52 and/or transports 54, or incremental changes therein, per convention in the art as adapted in accord with the teachings hereof. By way of non-limiting example, the published (or otherwise transferred) information can include (i) on-hand inventory, (ii) inventory subject to in-process orders, and/or (iii) inventory required for reserve at each of outlets 50, as well as inventory reasonably available for shipping from locations 52 and/or in transit via transports 54.

The event processing framework (or “event processor”) 62, executing in the data layer of server 12, logs and distributes those events 60 on a stream/broadcast and/or on-request basis to subscribing devices and/or processes, per convention in the art as adapted in accord with the teachings hereof. In the illustrated embodiment, the aforementioned inventory module 31A (of web application 31) is configured as one such a subscriber, again per convention in the art as adapted in accord with the teachings hereof. Although the illustrated embodiment utilizes event processing for transferring inventory data from outlets 50, locations 52 and transports 54 to inventory module 31A, other embodiments may utilize other data transfer methods and/or sources known in the art for such purpose, instead or in addition.

Upon invocation, e.g., in responding to a request 70, the inventory module 31A aggregates inventory data received from outlets 50, locations 52, transports 54 and/or other sources by subscription to framework 62, and filters that data in accord with specifics of the request, e.g., as to the product of potential interest to the user and inventory in stock or order-able via specific outlets 50 favorited by, frequented by and/or in the vicinity of the user of device 14A from which the request 70 issued and on which the recommendation 68 will be presented. Filtering of such aggregated data is within the ken of those skilled in the art in view of the teachings hereof. The web application 31 and/or module 31 can transfer that filtered, aggregated data 76 to the requesting browser for presentation to the user via browser 44 of device 14 A, along with the product recommendation—thereby, allowing the user to see not only recommended goods that may be of interest but their availability in inventory at nearby retail outlets and/or those favorited and/or frequented by the user.

This scenario can be repeated by devices 14A-14C, as their users continue browsing or otherwise interacting with the web site, with each recommendation corresponding to apparent product interests of the respective users of those devices and informed by inventory availability.

In order to reduce contention when updating records during high load on the system, some embodiments utilize the known pattern of event sourcing. In such embodiments, the framework 62, server 12, and/or inventory module 31A store events to represent changes in inventory. These are aggregated together in insertion order, resulting in a view of inventory details at the time of the most recently aggregated event.

Some embodiments aggregate inventory availability for a group of physical facilities, e.g. locations 52 and outlets 50, in a way that minimizes the impact of selling more stock than is available. The following pseudo code describes such an implementation. ATSI represents the Available to Sell Inventory for a specific stock unit. G represents a group of physical facilities. “Physical” stock is quantity on hand, “committed” is inventory that has been purchased and may or may not yet be shipped, and “safety stock” is inventory reserves that reduce the available count as described above. Although the following pseudo code details specific algorithms by way of example, it will be appreciated that other algorithms may be utilized to achieve like results.

```
ATSI(G):
for all locations L in G:
      sum L's physical - committed - safety stock - into
      TOTAL_AVAILABLE
      collect all groups to which L belongs into
INTERSECTING_GROUP_SET for all groups H in
INTERSECTING_GROUP_SET:
      for all locations K in both groups H and G:
            sum K's physical - committed - safety_stock into
            INTERSECTING_AVAILABLE
      subtract the lesser of (INTERSECTING_AVAILABLE and
      H.committed) from TOTAL_AVAILABLE
return TOTAL_AVAILABLE, rounding up to 0 if negative
ATSI(L):
put L's physical - committed - safety stock into
LOWEST_AVAILABILITY for all groups G to which L belongs:
      Replace LOWEST_AVAILABILITY with ATSI(G) if
ATSI(G) is lower return LOWEST_AVAILABILITY
```

Described above and shown in the drawings are apparatus, systems and method for inventory-informed artificial intelligence engine recommendations. It will be appreciated that the embodiments shown here are merely examples and that others fall within the scope of the claims set forth below. Thus, for example, although the discussion above focusses on product recommendations, it will be appreciated that this applies equally to the recommendation of other items and things.

In view of the foregoing, what is claimed is:

1. A method of generating digital data content customized for a user of a digital data platform, comprising:
determining, through artificial intelligence, potential interests of a user of a digital data platform,
generating, through artificial intelligence, a product recommendation based on the determined interests,
aggregating data from plural disparate sources regarding inventory availability,
filtering the aggregated data in accord with the product recommendation,
transferring the product recommendation, along with inventory availability, to a client digital data device for presentation to the user.

2. The method of claim 1, the determining step including monitoring communications between the platform and the client digital data device, where those communications include at least one of web pages, files and other content downloaded to the client digital data device and further include responses from the client digital data device to the downloaded content.

3. The method of claim 1, the determining step including inferring any of interests of the user and/or trends by monitoring any of (i) interactions between the platform and other users thereof, and (ii) social media feeds.

4. The method of claim 1, the determining step including accessing user data from any of account databases and other information maintained by or accessible to the platform.

5. The method of claim 1, the aggregating step including, with digital data processing equipment associated with plural disparate sources,
generating data with respect to those sources and publishing that data over a distributed network to an event processor.

6. The method of claim 5, the aggregating step including receiving the published data through subscription to the event processor and distributing that data to a plurality of requesting devices over the distributed network.

7. The method of claim 5, the filtering step including filtering the inventory data in accord with product information and locales specified in the product recommendation.

8. A machine readable storage medium having stored thereon a computer program configured to cause a digital data device to perform the steps of:
determining, through artificial intelligence, potential interests of a user of a digital data platform,
generating, through artificial intelligence, a product recommendation based on the determined interests,
aggregating data from plural disparate sources regarding inventory availability,
filtering the aggregated data in accord with the product recommendation,
transferring the product recommendation, along with inventory availability, to a client digital data device for presentation to the user.

9. Computer instructions configured to cause a digital data device to perform the steps of:
determining, through artificial intelligence, potential interests of a user of a digital data platform,
generating, through artificial intelligence, a product recommendation based on the determined interests,
aggregating data from plural disparate sources regarding inventory availability,
filtering the aggregated data in accord with the product recommendation,
transferring the product recommendation, along with inventory availability, to a client digital data device for presentation to the user.
